(19) United States
(12) Patent Application Publication
(10) Pub. No.: US 2015/0122554 A1
(43) Pub. Date: May 7, 2015

(54) METHOD FOR CHECK WEIGHING OF MATERIALS AND DEVICE THEREOF

(71) Applicant: MESNAC CO., lTD, QINGDAO, Shandong Province (CN)

(72) Inventors: Xiaoguang Yu, Qingdao (CN); Weimin Zhai, Qingdao (CN); Duohu Wang, Qingdao (CN)

(21) Appl. No.: 14/397,138

(22) PCT Filed: Mar. 12, 2013
(86) PCT No.: PCT/CN2013/072505

§ 371 Date: Oct. 24, 2014

(30) Foreign Application Priority Data
Apr. 25, 2012 (CN) 201210124001.8

(51) Int. Cl. G01G 23/01

(52) U.S. Cl. CPC G01G 23/01
USPC 177/1; 177/50

(57) ABSTRACT

The invention provides a method for check weighing of materials and a check weighing device thereof. Accurate weighing of materials is achieved through physical deformation of a sensing device (1) caused by a vertical downward force. When the induction device (2) detects the materials, the main transmission device (30) stops rotating and the vertical downward force on the weighing device transferred to the suspension mechanism (50) through the weighing device (40). The sensing device (1) deforms under the action of vertical downward force exerted by the suspension mechanism (50) to determine the weight of materials. Comparing prior weighing readings of materials after being proportioned with weighing readings of check weighing, the main transmission device (30) drives the materials to continuously move, the process of check weighing of materials is accomplished.

### FIELD OF THE TECHNOLOGY

The present invention relates to a method for achieving accurate weighing of materials through the physical deformation of a sensing device caused by a vertical pull force. The present invention mainly applies in weighing and verifying materials on a large scale with high accuracy, and belongs to the field for transporting rubbery or plastic materials.

### BACKGROUND OF THE INVENTION

At present, check weighing scales of carbon-steel structure are available for the production process of material transfer or check weighing of materials, such as being utilized in check weighing of formula of adhesives in manufacturing rubber tires.

The check weighing scale of carbon-steel structure is known for short weighing time. However, the accuracy of the check weighing scale is not high due to its heavy self weight and the sensors utilized with large strokes. Moreover, the deformation of the carbon-steel check weighing scale may lead to inaccurate weighing and further induce defects in formula of adhesives, and eventually affect the quality of products.

### SUMMARY OF THE INVENTION

The present invention provides a method for check weighing of materials and a check weighing device thereof with the aim of solving the above-mentioned problems in the prior art. The method for check weighing of materials comprises the following steps: exerting a vertical downward force due to gravity on a weighing device; transferring the vertical downward force exerted by materials to the ball-shaped components which are arranged at ends of the suspension mechanism and connected with concave brackets through rigid parts of the weighing device; detecting the deformation of a sensing device caused by the vertical downward force exerted by the suspension mechanism so as to weigh materials; comparing prior weighing readings of materials after being proportioned with weighing readings of check weighing to accomplish the process of check weighing of materials.

One of the objects of the present invention is to solve the problem of low accuracy in weighing materials due to impacts of external environment for improving accuracy in check weighing materials.

The second object of the present invention is to adjust the way of connecting the sensing device with check weighing scale. Hence, the suspension mechanism is utilized to connect the sensing device with the check weighing device. To be specific, the ball-shaped components arranged on the suspension mechanism are adopted to connect with concave brackets arranged at ends of the sensing device in an engaged manner, so as to achieve accurate weighing of materials.

Further, another object of the present invention is to replace the main frame of the weighing device made of carbon-steel material with aluminum material to effectively overcome the shortcoming of low accuracy in weighing caused by the self weight of check weighing scale, so as to improve the weighing accuracy of the weighing device.

In order to achieve the above-identified objects, the method for check weighing materials is described as follows:

As being transferred, proportioned materials which have been weighed are driven by a main transmission device to move forward. When the induction device which is at least mounted on one side of the weighing device detects the materials, the main transmission device stops rotating and the materials exert a vertical downward force on the weighing device due to gravity.

Then the vertical downward force exerted by the materials is transferred to the ball-shaped components which are arranged at ends of the suspension mechanism and connected with the concave brackets. The deformation of the sensing device caused by the vertical downward force exerted by the suspension mechanism is detected to weigh materials. After comparison of prior weighing readings of materials after being proportioned with weighing readings of check weighing, the process of check weighing of materials is accomplished.

One end of the sensing device is fixedly connected with the truss and the other end of the sensing device is connected with the main frame of the weighing device by the suspension mechanism, so as to lower the impact caused by external environment on the accuracy of the weighing device.

Both ends of the suspension mechanism are respectively fixedly connected with the sensing device and the concave brackets on the weighing device through the ball-shaped components of the suspension mechanism in an engaged manner and the contact area between each ball-shaped component and concave bracket is equal or less than 180 degrees, so as to realize the accurate weighing of materials.

In order to achieve the above-identified objects of the present invention, the check weighing device mainly comprises:

a main transmission device comprising a main driven roller and a driving motor which is arranged inside the main driven roller and used for driving convey belts to move in a cyclic manner;
a weighing device comprising the main frame, which may be made of aluminum for reducing the self weight of the check weighing device, and the truss used for bearing vertical pulling forces or stresses caused by loads;
a suspension mechanism comprising the ball-shaped components respectively connected with one end of the weighing device and one end of the sensing device, and metal pulling cords connected with the ball-shaped components.

The main transmission device which is used for driving materials to move forward is mounted at a lateral end of the main frame of the weighing device, and the induction device which is used for detecting the position of materials is fixedly arranged on at least one side of the main frame of the weighing device.

One or more groups of the sensing devices are fixedly arranged under the main frame of the weighing device. One end of the sensing device is connected with the main frame of the weighing device through the suspension mechanism. Each concave bracket of the suspension mechanism is vertically inserted into the adjustment wire thread insert and the adjusting device which is used for preventing the metal pulling cords from deviating from orthocenter is vertically connected outside the adjustment wire thread insert in a sleeved manner, so as to ensure the metal pulling cords keeping vertically. The truss of the weighing device is respectively connected with the support legs through U-shaped brackets, so as to ensure accurate check weighing of materials.

As described in the above-mentioned basic technical solution, materials exerts vertical downward force on the weighing device due to gravity, the vertical downward force exerted by the materials is transferred to the ball-shaped components which are arranged at ends of the suspension mechanism and connected with the concave brackets. The deformation of the sensing device caused by the vertical downward force exerted by the suspension mechanism is detected to weigh materials.

In summary, the method for check weighing of materials and the check weighing device thereof has the advantages and positive results in that:
1. Accurate weighing of materials is achieved by adjusting the way of connecting the sensing device with the body of the check weighing device, and namely the suspension mechanism is utilized to connect the sensing device with the check weighing device.
2. The impact of external environment on check weighing of materials is reduced to improve the accuracy of weighing materials.
3. The main frame of the weighing device made of carbon-steel materials is replaced with aluminum material, so as to overcome the shortcoming of low accuracy in weighing caused by its heavy self weight and improve the accuracy in check weighing.

### BRIEF DESCRIPTION OF THE DRAWINGS

With reference to the below drawings, detailed description of the present invention is presented as follows:

FIG. 1 is the front view of the check weighing device;

FIG. 2 is the side view of the check weighing device;

FIG. 3 is the partial schematic diagram of the check weighing device; and

FIG. 4 is the section view of the suspension mechanism.

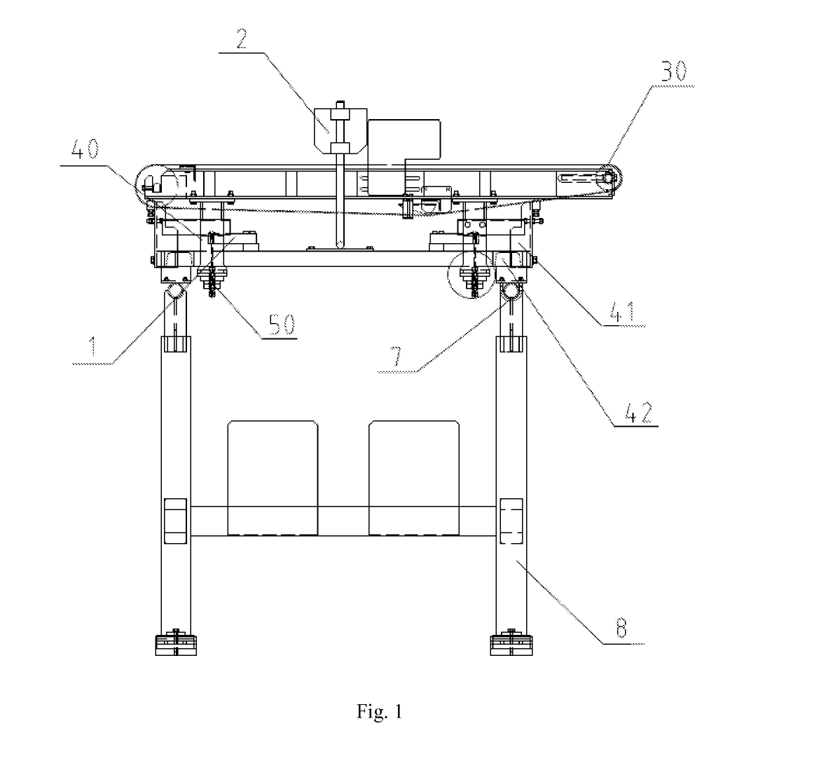

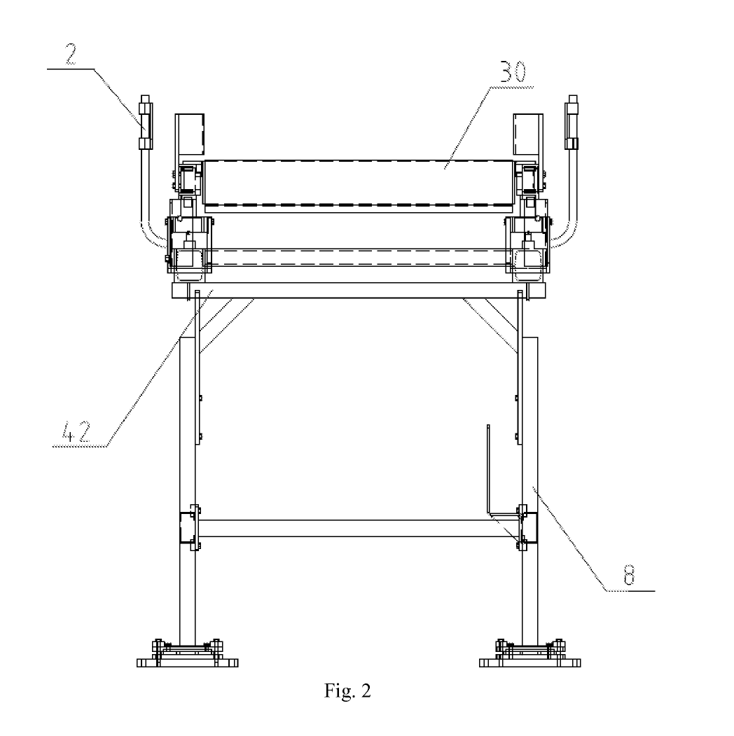

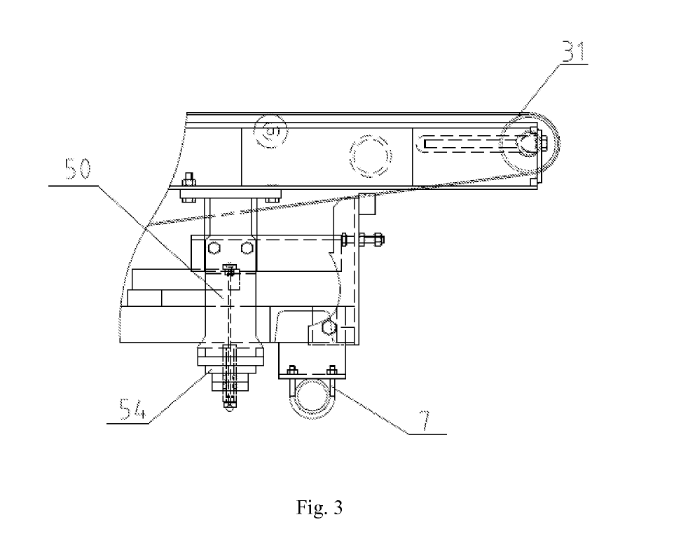

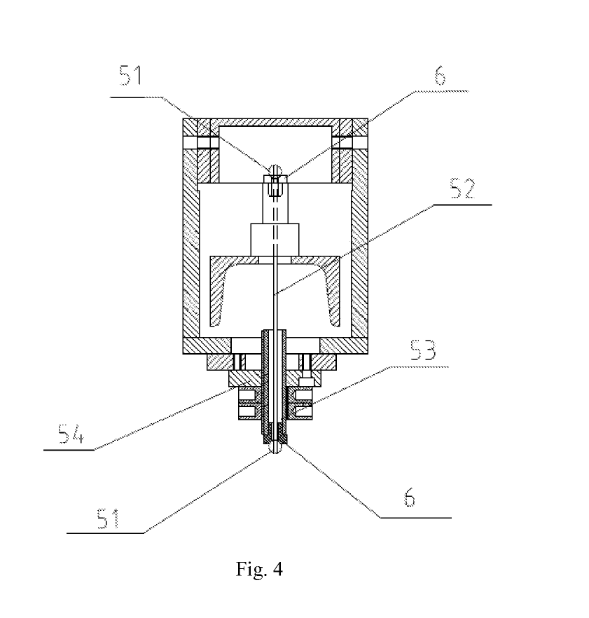

As shown in the FIG. 1, FIG. 2, FIG. 3 and FIG. 4, reference numerals representations are as follows: the sensing device 1, the induction device 2, the main transmission device 30, the main driven roller 31, the weighing device 40, the main frame 41, the truss 42, the suspension mechanism 50, the ball-shaped component 51, the metal pulling cord 52, the adjustment wire thread insert 53, the adjusting device 54, the concave bracket 6, the U-shaped bracket 7 and the support leg 8.

### DETAILED EMBODIMENT OF THE PRESENT INVENTION

### Embodiment 1

As shown in the FIG. 1, FIG. 2, FIG. 3 and FIG. 4, the method for check weighing materials is described as follows.

During the materials transportation process, proportioned materials which have been weighed are driven by the main transmission device 30 to move forward. When the induction device 2 which is at least mounted on one side of the weighing device 40 detects the materials, the main transmission device 30 stops rotating and the materials exert a downward vertical force due to gravity on the weighing device 40.

Meanwhile, the vertical force exerted by the materials is transferred to the ball-shaped components 51 which are positioned at one end of the suspension mechanism 50 and connected with the concave brackets 6 through rigid parts of the weighing device 40. The deformation of the sensing device 40 occurs due to the downward force passing by the suspension mechanism 50 so as to weigh materials. After comparison of the weight readings of the materials after being proportioned with the check weighing readings, the process of check weighing of materials is completed.

One end of the sensing device 1 is fixedly connected with the truss 42 and the other end of the sensing device 1 is connected with the main frame 41 of the weighing device 40 through the suspension mechanism 50, so as to lower the impact caused by external environment on the accuracy of the weighing device.

Both ends of the suspension mechanism 50 are respectively fixedly connected with the sensing device 1 and the concave brackets 6 on the weighing device 40 through the ball-shaped components 51 of the suspension mechanism 50 in an engaged manner and the contact area between each ball-shaped component 51 and concave bracket 6 is equal or less than 180 degrees, so as to realize the accurate weighing of materials.

In order to achieve the above-identified objects, the check weighing device utilized mainly comprises:

a main transmission device 30 comprising the main driven roller 31 and a driving motor which is arranged inside the main driven roller 31 and used for driving convey belts to move in a cyclic manner;
a weighing device 40 comprising a main frame 41 made of aluminum for reducing the self weight of the check weighing device and the truss 42 used for bearing vertical pulling forces or stresses caused by loads;
a suspension mechanism 50, which includes the ball-shaped components 51 respectively connected with one end of the weighing device 40 and one end of the sensing device 1, and metal pulling cords 52 connected with the ball-shaped components 51, the metal pulling cords 52 being made of steel wire.

The main transmission device 30 which is used for driving materials to move forward is mounted at a lateral end of the main frame 41 of the weighing device 40, and the induction device 2 which is used for detecting the position of materials is fixedly arranged on at least one side of the main frame 41 of the weighing device 40.

One or more groups of the sensing devices 1 are fixedly arranged under the main frame 41 of the weighing device 40. One end of the sensing device 1 is connected with the main frame 41 of the weighing device 40 through the suspension mechanism 50. The concave bracket 6 of the suspension mechanism 50 is vertically inserted into the adjustment wire thread insert 53 and the adjusting device 54 which is used for preventing the metal pulling cords 52 from deviating from orthocenter is vertically connected outside the adjustment wire thread insert 53 in a sleeved manner, so as to ensure the metal pulling cords 52 being kept vertical. The truss 42 of the weighing device 40 is respectively connected with the support legs 8 through the U-shaped bracket 7, so as to ensure accurate check weighing of materials.

1. A method for check weighing of materials to determine the weight of materials which have been proportioned and weighed before being processed by internal mixers by a check weighing device and is characterized in that:
the check weighing device comprises a main transmission device which is used for driving materials to move, a weighing device which is used for weighing materials and a suspension mechanism which is connected with a sensing device and the weighing device;
as an induction device which is at least fixed on one side of the weighing device detects the materials, the main transmission device stops rotating and materials exert a vertical downward force due to gravity on the weighing device;
the vertical force exerted by materials is transferred to ball-shaped components which are arranged at ends of the suspension mechanism and connected with concave brackets through rigid parts of the weighing device, the sensing device physically deforms under the action of the downward force exerted by the suspension mechanism to determine the weight of materials; weighing readings of check weighing is compared with prior weighing readings of the materials after being proportioned;
upon completion of reading comparison, the materials are driven by the main transmission device to move forward, so as to complete check weighing of the materials.

2. The method for check weighing of materials according to the claim 1, characterized in that: one end of the sensing device is fixedly connected with a truss and the other end of the sensing device is connected with a main frame of the weighing device so as to lower impact of external environment on accuracy of the weighing device.

3. The method for check weighing of materials according to claim 1, is characterized in that: both ends of the suspension mechanism are respectively fixedly connected with the sensing device and the concave brackets on the weighing device through the ball-shaped components at the suspension mechanism in an engaged manner and the contact area between each ball-shaped component and concave bracket is equal or less than 180 degrees, so as to realize the accurate weighing of materials.

4. A check weighing device for achieving the method for check weighing of materials according to claim 1, characterized in that:
the main transmission device comprises a main driven roller and a driving motor which is arranged inside the main driven roller and used for driving convey belts to move in a cyclic manner;
the weighing device comprises a main frame made of aluminum for reducing self weight of the check weighing device and a truss used for bearing vertical pulling forces or stresses caused by loads;
the suspension mechanism comprises the ball-shaped components respectively connected with one end of the weighing device and one end of the sensing device, and metal pulling cords connected with the ball-shaped components and an adjusting device.

5. The check weighing device according to the claim 4, characterized in that: the main transmission device which is used for driving materials to move forward is mounted at a lateral end of the main frame of the weighing device, and the induction device which is used for detecting the position of materials is fixedly arranged on at least one side of the main frame of the weighing device;
one or more groups of the sensing devices are fixedly arranged below the main frame of the weighing device, and one end of the sensing device is connected with the main frame of the weighing device through the suspension mechanism.

6. The check weighing device according to claim 4, characterized in that: concave brackets of the suspension mechanism are vertically inserted into an adjustment wire thread insert and the adjusting device which is used for preventing the metal pulling cords from deviating from orthocenter is vertically connected outside the adjustment wire thread insert in a sleeved manner.

7. The check weighing device according to claim 6, characterized in that: the truss of the weighing device is respectively connected with the support legs through U-shaped brackets.

8. The method for check weighing of materials according to claim 2, is characterized in that: both ends of the suspension mechanism are respectively fixedly connected with the sensing device and the concave brackets on the weighing device through the ball-shaped components at the suspension mechanism in an engaged manner and the contact area between each ball-shaped component and concave bracket is equal or less than 180 degrees, so as to realize the accurate weighing of materials.

9. A check weighing device for achieving the method for check weighing of materials according to claim 2, characterized in that:
the main transmission device comprises a main driven roller and a driving motor which is arranged inside the main driven roller and used for driving convey belts to move in a cyclic manner;
the weighing device comprises a main frame made of aluminum for reducing self weight of the check weighing device and a truss used for bearing vertical pulling forces or stresses caused by loads;
the suspension mechanism comprises the ball-shaped components respectively connected with one end of the weighing device and one end of the sensing device, and metal pulling cords connected with the ball-shaped components and an adjusting device.

10. A check weighing device for achieving the method for check weighing of materials according to claim 3, characterized in that:
the main transmission device comprises a main driven roller and a driving motor which is arranged inside the main driven roller and used for driving convey belts to move in a cyclic manner;
the weighing device comprises a main frame made of aluminum for reducing self weight of the check weighing device and a truss used for bearing vertical pulling forces or stresses caused by loads;
the suspension mechanism comprises the ball-shaped components respectively connected with one end of the weighing device and one end of the sensing device, and metal pulling cords connected with the ball-shaped components and an adjusting device.

11. The check weighing device according to claim 5, characterized in that:
concave brackets of the suspension mechanism are vertically inserted into an adjustment wire thread insert and the adjusting device which is used for preventing the metal pulling cords from deviating from orthocenter is vertically connected outside the adjustment wire thread insert in a sleeved manner.
